(19) United States
(12) Patent Application Publication
(10) Pub. No.: US 2022/0023150 A1
(43) Pub. Date: Jan. 27, 2022

(54) Memory Device

(71) Applicant: Kevin Taylor, Ogden, UT (US)

(72) Inventor: Kevin Taylor, Ogden, UT (US)

(21) Appl. No.: 17/356,236

(22) Filed: Jun. 23, 2021

Related U.S. Application Data
(63) Continuation-in-part of application No. 16/526,955, filed on Jul. 30, 2019.
(60) Provisional application No. 62/780,852, filed on Dec. 17, 2018.

(51) Int. Cl. A61J 7/04; G06F 3/02

(52) U.S. Cl. CPC A61J 7/04; G06F 3/0219

(57) ABSTRACT

A learning and memory device is disclosed. The learning and memory device includes a flexible plate with manually pressable and resettable buttons disposed in the plate for assisting with memory. Each button includes a button head including an upper protrusion and an underside protrusion. In another aspect the device includes a flexible plate with manually pressable and resettable buttons disposed in the plate for assisting with memory. Each button includes a button head including an upper protrusion and an underside protrusion. The button head of each button is connected to a tapered conical portion. The tapered conical portion extends from a periphery of the button head outwardly to connect with the flexible plate. The conical portion allows for the button head to be pressed into the flexible plate and allows the button head to snap into the pressed in position.

### CROSS-REFERENCE TO RELATED APPLICATIONS§

This patent application claims priority to U.S. Provisional Patent Application No. 62/780,852 filed Dec. 17, 2018 and is a continuation-in-part of U.S. patent application Ser. No. 16/526,955 filed Jul. 30, 2019, the contents of which are hereby incorporated herein for all purposes.

### TECHNICAL FIELD

The present invention relates to systems and apparatus for learning and memory.

### BACKGROUND

Learning and memory are often enhanced when multiple senses are engaged in the process of learning. Engaging multiple senses creates multiple pathways to access memory and assists in accessing the memory.

### SUMMARY

In a first aspect, the disclosure provides a learning and memory device. The learning and memory device includes a flexible plate with manually pressable and resettable buttons disposed in the plate for assisting with memory. Each button includes a button head including an upper protrusion and an underside protrusion.

In a second aspect, the disclosure provides a learning and memory device. The learning and memory device includes a flexible plate with manually pressable and resettable buttons disposed in the plate for assisting with memory. Each button includes a button head including an upper protrusion and an underside protrusion. The button head of each button is connected to a tapered conical portion. The tapered conical portion extends from a periphery of the button head outwardly to connect with the flexible plate. The conical portion allows for the button head to be pressed into the flexible plate and allows the button head to snap into the pressed in position.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 illustrates a medication tracking device and illustrates such device affixed to a medication container;

FIG. 2 shows the medication tracking device from a front top perspective view and from a side view with each button being placed in an original reset position;

FIG. 3 shows the medication tracking device from a rear top perspective view and side view where all of the buttons have been pressed in;

FIG. 4 shows the medication tracking device from the front with a human finger pressing one of the buttons in, a view from the rear and a second view from the rear of the tracking device showing a human finger resetting one of the buttons;

FIG. 5 shows two cross-sectional views of the medication tracking device and illustrating the portions of the innovative button structure thereof;

FIG. 6 shows the disassembled top and bottom views of the parts of the medication tracking device prior to assembly;

FIG. 6A shows a disassembled view of a memory device

FIG. 7 shows the assembled parts of the medication tracking device and side view of the button structure along with examples of various dimensions according to certain embodiments thereof; and

FIG. 8 illustrates additional layouts and forms of other medication tracking devices.

FIG. 9 shows a layout of an alphabet memory device.

FIG. 10 shows a memory device as a keyboard.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

Learning is generally more effective when combining visual associations with the subject being learned than by memorization. Association also creates pathways that retain the facts or knowledge associated with the visual representation longer. These pathways can be further strengthened by adding a physical movement to the visual association. Learning devices that incorporate play into the learning of facts or processes, are methods that help learn and retain that learning. Toys or learning devices that increase the creation of these pathways in the brain increase the brains ability to remember and access information.

Sometimes the mere association of a movement with a fact will increase the ability of the brain to recall that fact. Spinning a pencil or pen around the fingers or playing with a “fidget spinner” can increase the ability of the brain to remember a fact. Pens and fidget spinners often have little to no association with the facts that are being remembered.

One embodiment of the invention is a popper to assist in learning and remembering facts. These embodiments utilize a toy or device with pressable buttons, where each button is associated with a number or a letter. The device allows the buttons to be pressed and to stay in the pressed state, so that every button that has been pressed is in a down configuration while the buttons that have not been pressed remain in the up position. The buttons could also be pressed from the backside so that the buttons that have been pressed are in the up position and the buttons that have not been pressed are in the down position.

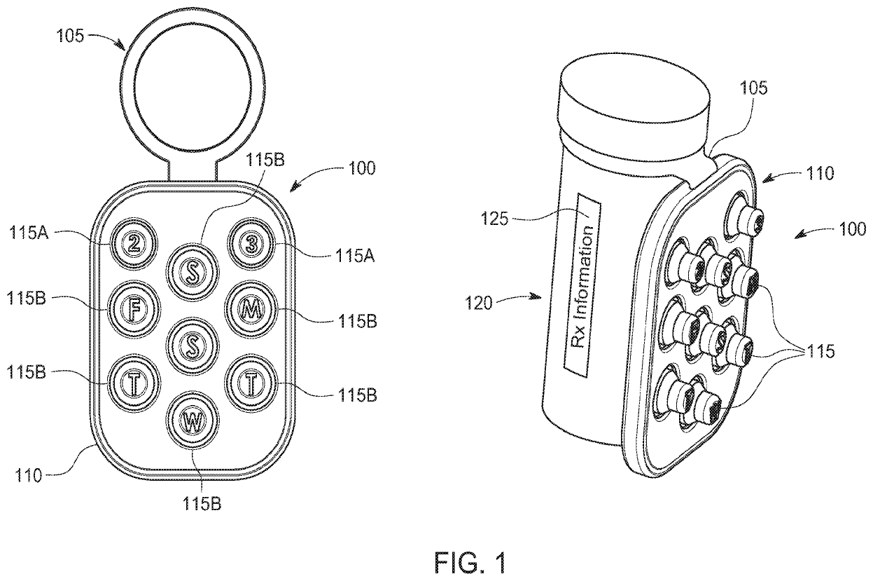

Physical and visual associations help in initial learning and in retaining previously learned subjects. Some embodiments of the invention relate to medication tracking systems, apparatus, methods for manufacture thereof, and methods of use. Embodiments of the invention also relate to a unique button design which is easily depressible (“popped in”) and easily resettable (“popped out”) using certain functional features particularly articulable by a human finger or thumb. Other additional unique features, embodiments and uses thereof are disclosed hereinafter with reference to the figures. Referring to FIGS. 1, 2, and 3 a tracking device 100 is shown according to an embodiment of the invention. The tracking device 100 includes means for connecting the tracking device 100 to a bottle 120. The means for connecting the tracking device 100 can include a substantially circular shaped elastic loop 105 for holding the tracking device 100 to the bottle 120. The bottle 120 can be a prescription bottle or bottle of supplements, for example. The flexible loop 105 can be sized and shaped for a particular size of prescription bottle. The flexible loop 105 may also be substantially flexible to be highly stretchable in some embodiments so as to accommodate a wide range of bottle diameters of several times the loop's 100 original unstretched diameter.

For example, the tracking device 100 shown in FIG. 1 can be designed to help a patient keep track of the administration of medication according to the associated prescription set forth on the label 125 of the bottle. As shown in FIG. 1, the tracking device 100 can be attached to the bottle 120 of medication by stretching the loop 105 around an outer periphery of the bottle 120. In this manner the medicine may continue to be held and stored within the original prescription bottle 120 along with the original prescription instructions 125 placed on the bottle 120 by the pharmacy. These prescription instructions 125 can include the time and quantity of pills to be taken each day, for example.

Because the tracking device 100 is kept with the original bottle 120, or other original container of medication, the original child-proof safety measures of the original bottle 120 are also retained. As previously discussed, traditional medication tracking containers require the medication to be removed from the original container and do not implement sufficiently secure child proof measures to prevent accidental access to the medication by children. As shown in FIG. 1 the original medication bottle and child-proof cap are used so as to prevent such inadvertent access by children.

In addition, the tracking device 100 may be used with medications that cannot easily be removed from their original container. For example, the tracking device may be connected to the original bottle of liquids, sprays, drops, creams and other applied or ingested substances. Traditional tracking boxes and other traditional devices are not built to accommodate such substances.

According to several preferred embodiments disclosed herein, batteries and electronics can be excluded. Therefore, the tracking device 100 is truly reusable. Furthermore, the tracking device 100 can have particular advantages in low-income areas in the United States and around the world to help with adherence for low-income people in need of a reliable solution that does not require batteries, recharging, or even electricity. The lack of electrical reliance also makes the tracking device 100 more reliable and has a reduction of parts and reduced likelihood of failure.

The tracking device 100 includes multiple depressible and resettable buttons 115. The buttons can be pressed in (e.g., “popped in”) when a dose has been administered. Upon subsequent review of the tracking device 100 the pressed-in buttons will indicate that a particular dosage has been administered. Once a regimen of dosage administration has been completed, the pressed-in buttons 115 can be reset by pressing on an under side of the pressed-in buttons so as to reset (e.g., “pop out”) the buttons 115.

The position of the buttons can also be felt m addition to visually noticed. Therefore, someone with a lower ability to see may be able to feel the position of the buttons so as to tactically feel the position of the various button with reference to the loop indicating a top thereof.

The buttons 115 can include indicia for tracking multiple individual doses of medication for administration. The indicia can be visual, tactile, or a combination thereof. The indicia on the buttons 115 can be raised and can have a letter, number or other descriptive indication of the relevance of the button for tracking the administration of medication according to the day of the week and/or time of day, for example.

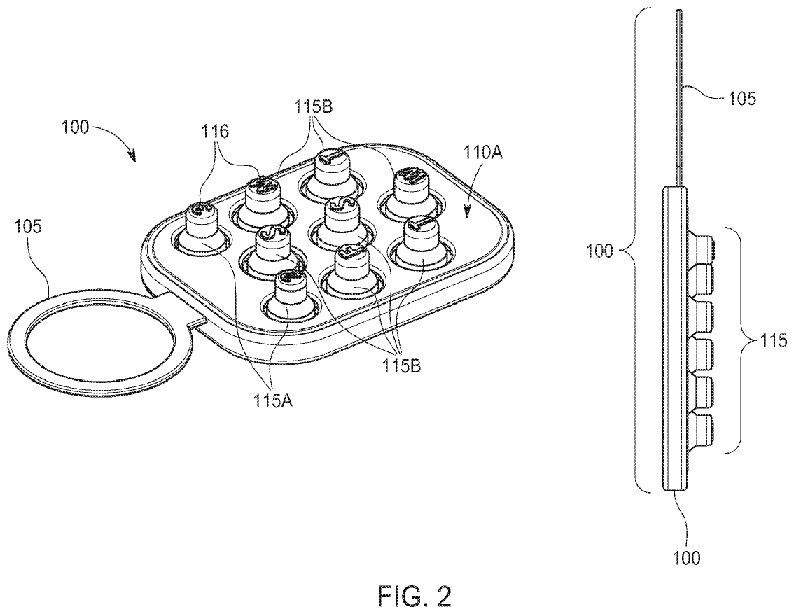

Referring to FIGS. 1 and 2, which show an embodiment utilizing a tracking device, the tracking device 100 includes a first set of buttons 115A for tracking the number of the dose in a day, and a second set of buttons 115B for tracking each day of a week. As shown, the first set of buttons have a “2” and a “3” indicia in this embodiment for tracking a second and third dose of medication, the first dose indicated when neither the “2” or “3” buttons are pressed in. The second set of buttons 115B indicate the day of the week. Thus, a first of the second set of buttons 115B has an “M” associated with Monday, a second of the second set of buttons 115B has a “T” associated with Tuesday, a third of the second set of buttons 115B has a “W” associated with Wednesday, and so forth.

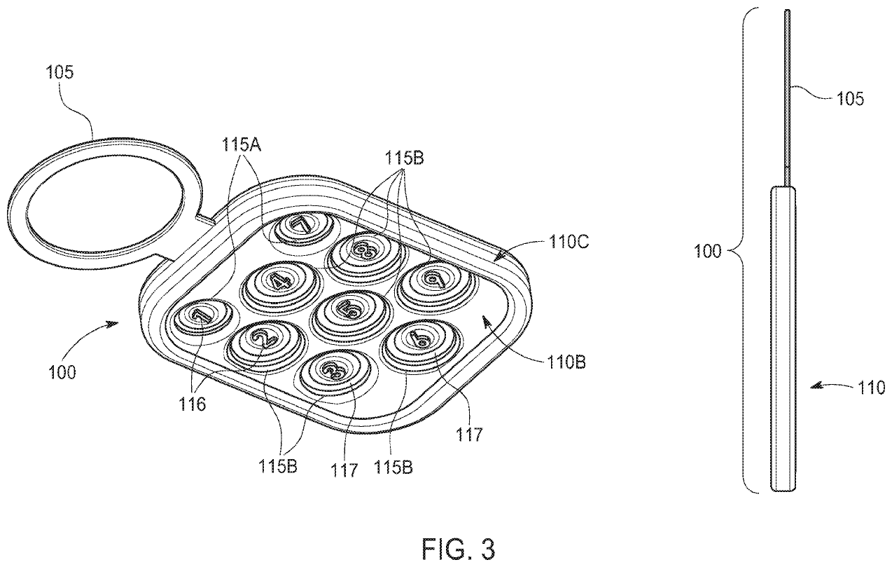

FIG. 3 shows the tracking device from a rear perspective view and a side view having the buttons 115 press “popped” in. As shown in the side view of FIG. 3, the underside 11OB of the tab 110 is recessed from an outer peripheral lip 11OC of the tab 110 such that the buttons do not extend beyond the outer peripheral lip 1IOC of the tab 110 when pressed in as shown from the side view of the tracking device 100 in FIG. 3.

According to the teachings of certain embodiments disclosed herein, it is important that the underside of the buttons 115 do not extend beyond the outer peripheral lip 11OC such that when placed upon a flat surface, such as on the surface of a table, the underside of the buttons 115 are not inadvertently reset. In addition to the buttons not being inadvertently reset, the recessed surface 11OB of the tab 110 relative to the outer peripheral lip 11OC further allows for more easy access to the underside of the buttons 115 for the tip of a person's finger to reset the buttons 115. According to certain embodiments, the depth of the recessed inner surface 11OB can extend about 0.7 millimeters below the upper surface of the outer peripheral rim 1IOC so as to accommodate the underside protrusions 117 of the buttons 115. For example, according to such embodiments, the protrusions 117 of the buttons 115 extend approximately 0.4 millimeters above the inner surface 110B allowing for approximately 0.3 millimeters of space between the top of the underside protrusion 117 and the upper surface of the outer peripheral rim 1IOC in this example.

To allow for more easy access to reset the buttons 115, with particular design for the size of a human finger, the buttons 115 can include an underside articulable protrusion 116 extending therefrom from the center of the underside of the buttons 115. The underside of the buttons 115 can include indicia 116, in this example simply numbering the underside of the buttons 115. The indicia 116 can include raised numbers and letters as shown allowing for manual manipulation by the human fingertip.

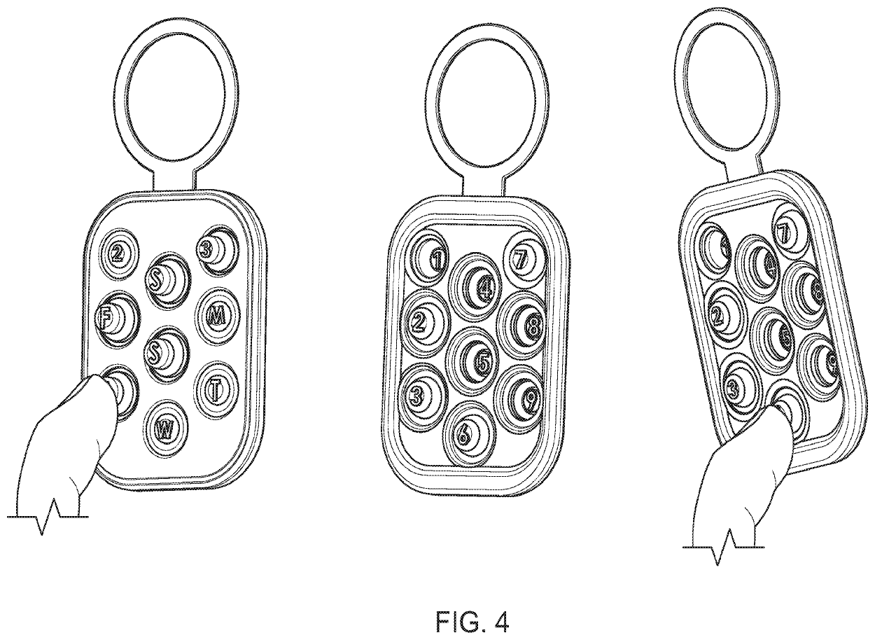

FIG. 4 illustrates the use of tracking device 100, wherein a finger is used to press-in “pop in” the first button labeled “2” of the first set of buttons 115A indicating that the second dose of Wednesday has been taken. As shown, the first three buttons of the second set of buttons 115B have been pressed in indicating that the dosage prescribed for Monday, Tuesday, and Wednesday have been taken. FIG. 4 also illustrates the back side of the tracking device 100 having the same buttons pressed in. As shown, each button has an underside protrusion extending therefrom for articulation by a human finger as shown in FIG. 4 so as to reset each button using a finger pressing against such underside as illustrated.

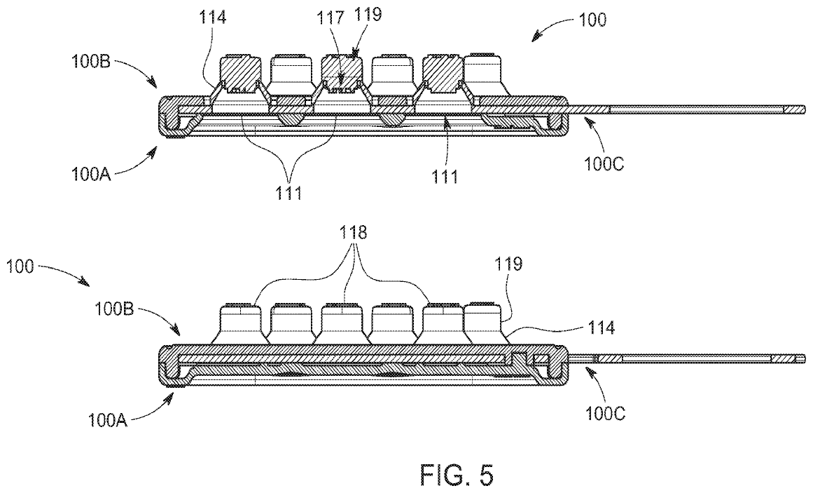

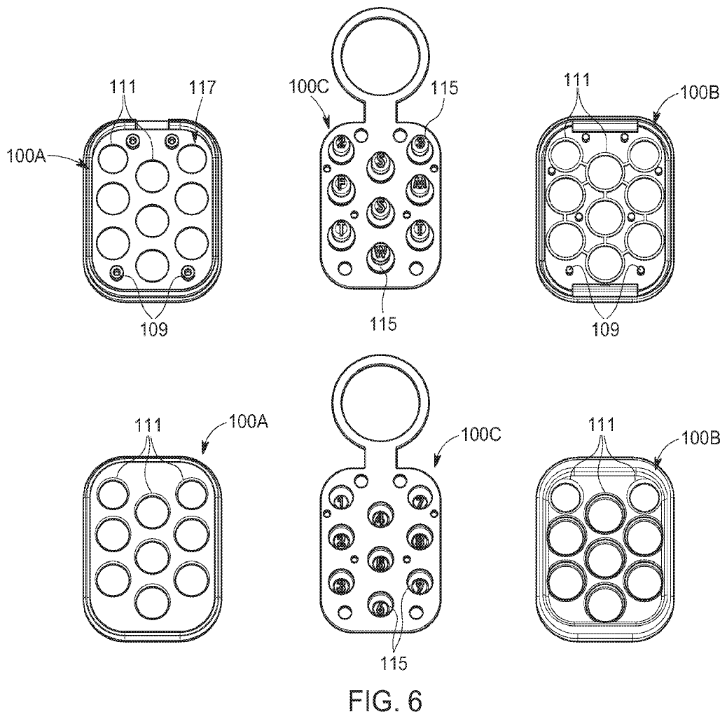

FIG. 5 illustrates cross sectional views of the tracking device 100 with particular emphasis on the assembly thereof. FIG. 6 shows the disassembled parts of the tracking device 100. With cross-reference to FIGS. 5 and 6, the tracking device 100 includes two injected molded plastic shell parts IO0A and 100B and a third compression molded silicone part IO0C. The plastic parts IO0A and 100B lend rigidity to the tab portion 110 of the tracking device 100. The silicone part IO0C provides flexibility and elasticity to the buttons 115 and loop 105 of the tracking device. Thus, the silicone part IO0C can be manufactured as a single integral silicone part without the use of adhesives, seams, or multiple different manufacture processes according to this example embodiment.

The plastic parts 100A and 100B can have recessed holes 111 as shown in the disassembled illustrations of FIG. 6 to accommodate and allow access to the buttons 115 so as to manipulate the button into the different positions through the recessed holes 111. The underside 110A of the tab 110 can be recessed as shown from the outer peripheral rim 1IOC so as to accommodate the pressed in buttons (e.g., see FIG. 3). The plastic parts IO0A and 100B can be snap-fit together using peg and hole connections and the silicone part IO0C can have holes located and disposed there through and aligned with the locations of the holes and pegs of the plastic parts for easy assembly thereof.

As shown in FIG. 5, each button 115 can have a head 118 including a top protrusion 119 and the bottom protrusion 117. The head 118 can be formed as the solid button head 118. The button heads 118 are connected by a conically tapering portion 114 surrounding each button head 114. The conical portions 114 are formed integral with and extend at an angle to the button heads 118 and relative to the plastic portions IOOA and 100B which securely hold the relatively larger outer periphery of the conical connecting portions 114 of the buttons 118. These conically tapering connections 114 are made of the flexible and deformable silicone allowing for deformation under manual manipulation into the recessed popped-in position and back into the reset popped-out position. When manually placed into the two different positions, the flexible conical connections 114 hold the button 115 in its popped-in or popped-out reset position. And the opposing upper side protrusion 119 and under side protrusion 117 of the button heads 118 allow for easier fingertip articulation thereof. Thus, the size and extension distance of the upper protrusion 119 and underside protrusion 117 have been specifically selected and optimized by the inventor of this patent application for its particular applications, however the teachings disclosed herein can be applied and optimized to other buttons applications.

FIG. 6A. shows an embodiment of the invention focused on improving memory and the gamification of memory improvement. FIG. 6A shows the disassembled parts of the learning and memory device 100. The learning and memory device 600 includes two injected molded plastic shell parts 6O0A and 600B and a third compression molded silicone part 6O0C. The plastic parts 6O0A and 600B lend rigidity to the memory device 600. The silicone part 6O0C provides flexibility and elasticity to the buttons 615 of the memory device. Thus, the silicone part 6O0C can be manufactured as a single integral silicone part without the use of adhesives, seams, or multiple different manufacture processes according to this example embodiment.

The plastic parts 600A and 600B can have recessed holes 611 as shown in the disassembled illustrations of FIG. 6A to accommodate and allow access to the buttons 615 so as to manipulate the button into the different positions through the recessed holes 611. The underside 610A can be recessed from the outer peripheral rim 61OC so as to accommodate the pressed in buttons (e.g., see FIG. 3). The plastic parts 6O0A and 600B can be snap-fit together using peg and hole connections and the silicone part 6O0C can have holes located and disposed there through and aligned with the locations of the holes and pegs of the plastic parts for easy assembly thereof.

The learning and memory device is sized to be comfortable to hold and there are various sizes to accommodate different sized hands. In some embodiments the length of the number learning and memory device is between 10 centimeters and 30 centimeters. In other embodiments, the length is between 12 and 20 centimeters. In yet another embodiment, the length is between 14 and 16 centimeters. In some embodiments, the width of the device is between 6 centimeters and 20 centimeters. In another embodiment, the width is between 8 and 16 centimeters. In yet another embodiment, the width is between 10 and 12 centimeters. The buttons are proportionally sized for the size of the device. The dimensions of the buttons will increase with the size of the device.

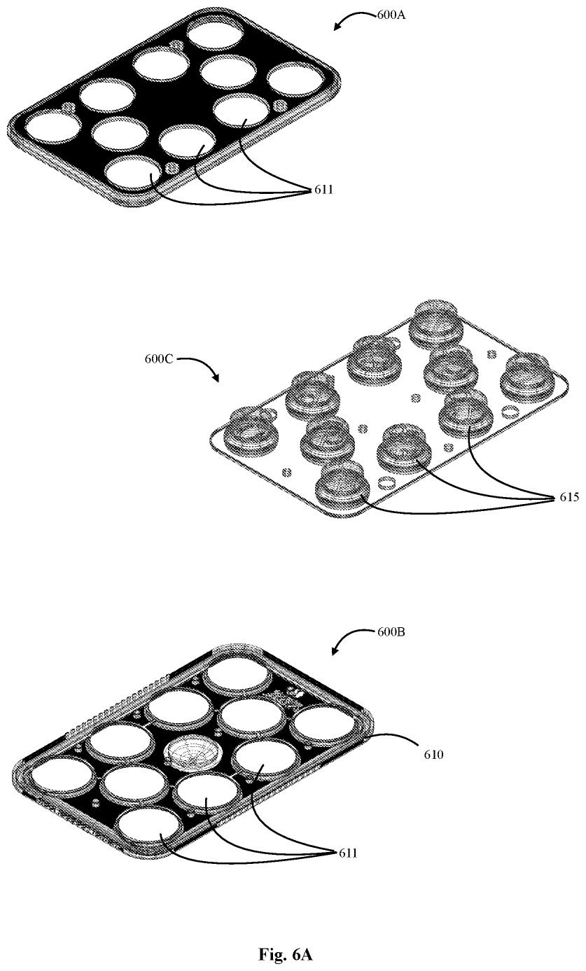

FIG. 7 illustrates some examples of dimensions in millimeters. Such dimensions can vary by 10%, 20% or more or less depending on the application. For example, a through hole dimension of 12.75 millimeters can be between about or equal to 10 and 15 millimeters and a button head diameter can be between about or equal to 4 and 7 millimeters. Similarly, an upper head height dimension can be between about 1 and 3 millimeters and a distance between a conical head upper and lower diameters can be between about 2 and 5 millimeters. The thickness of the assembled tab portion can be between 3 and 7 millimeters and the height between about 40 and 70 millimeters and width between about 30 and 60 millimeters according to some embodiments. Examples of some advantageous dimensions are disclosed herein. Certain dimensions are illustrated therein as examples of some embodiments but should not be considered as limiting as to the invention and claims. Such dimensions, shapes and sizes may be appropriately enlarged, reduced, modified and optimized for a particular application and package design, shape and size to which the system 100 is meant to be applied.

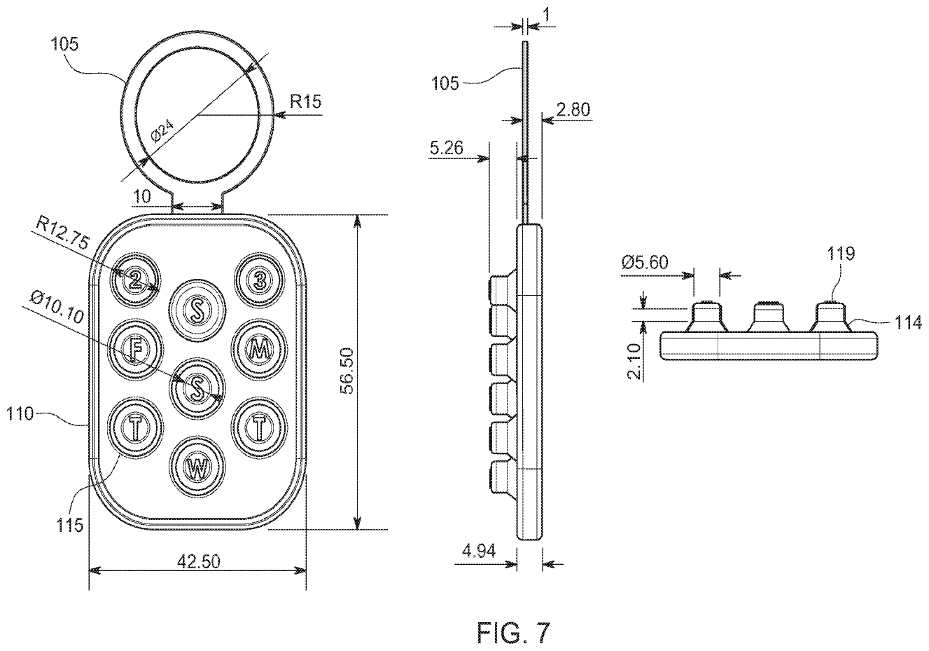

Multiple different layouts of the tracking device are illustrated in FIG. 8. Some embodiments of the tracking devices are for use with medication that is taken once per day. Other embodiments are for medications that are taken multiple times per day.

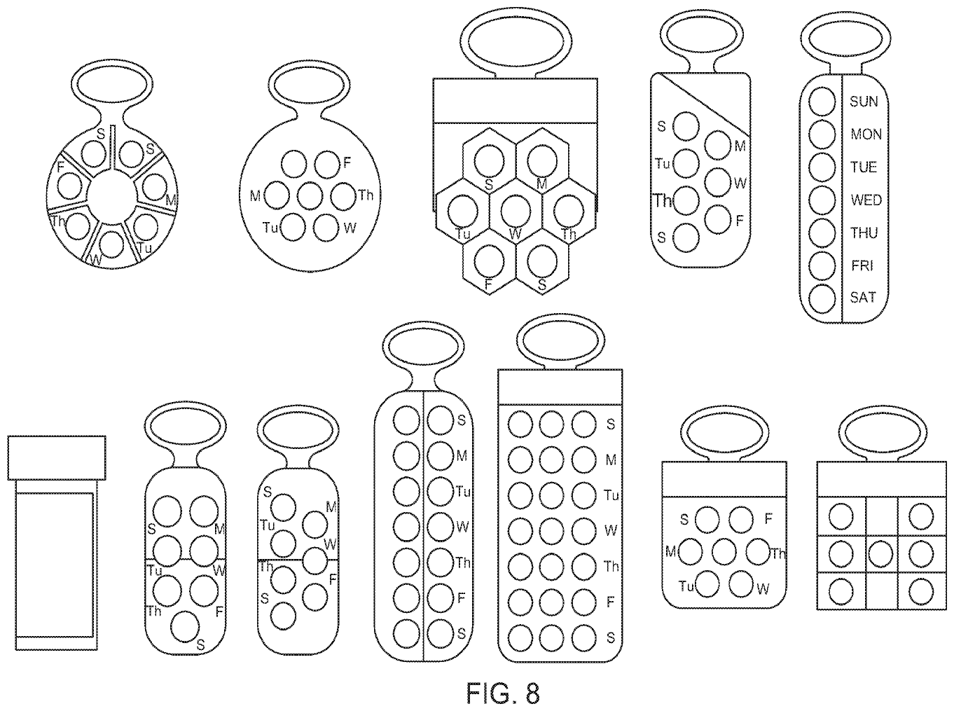

FIG. 9 shows an embodiment of a memory device. This embodiment shows an alphabet device 900 where each button of the memory device is a letter of the alphabet. In this embodiment the buttons are pressed down as the learner recites them. The visual and physical association with the letters increases the ability to learn and access each letter. The learning can be further increased by associating the sound each letter makes, thus helping learn the sounds of the letters. In the depicted embodiment the letters are arranged alphabetically in four rows.

The learning and memory device is sized to be comfortable to hold and there are various sizes to accommodate different sized hands. In some embodiments the length of the number learning and memory device is between 12 centimeters and 40 centimeters. In other embodiments, the length is between 15 and 30 centimeters. In yet another embodiment, the length is between 14 and 16 centimeters. In some embodiments, the width of the device is between 6 centimeters and 25 centimeters. In another embodiment, the width is between 10 and 16 centimeters. In yet another embodiment, the width is between 12 and 16 centimeters. The buttons are proportionally sized for the size of the device. The dimensions of the buttons will increase with the size of the device.

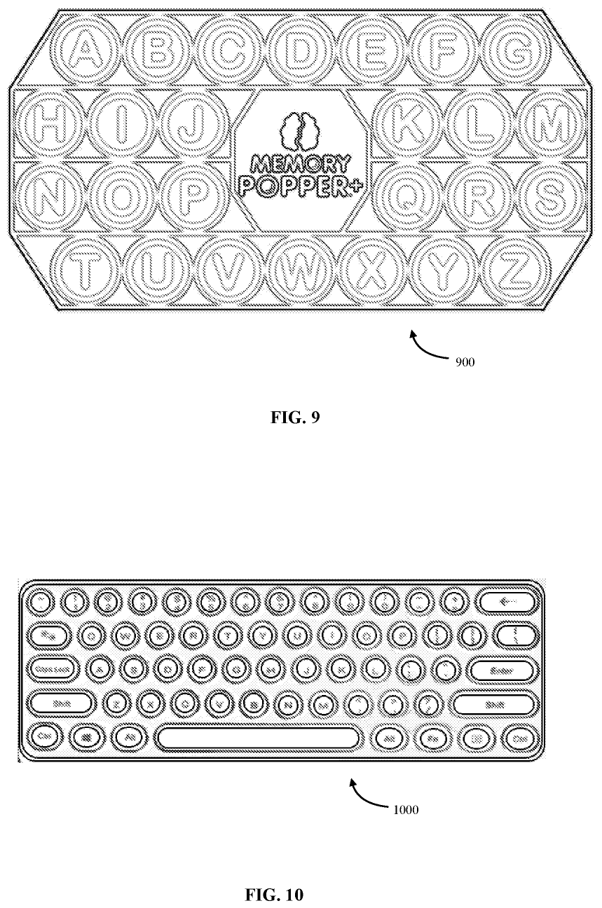

In another embodiment, shown in FIG. 10 the learning device is a QWERTY keyboard 1000. This learning device is configured so that learners can become familiar with the location of the letters, numbers, and functions of a keyboard. Each key of the keyboard is formed as a depressible and repressible button. In another embodiment, the keyboard includes only the letters in the QWERTY orientation. In yet another embodiment, the device includes the letters and numbers without the function keys.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All patents and published patent applications referred to herein are incorporated herein by reference. The invention has been described with reference to various specific and preferred embodiments and techniques. Nevertheless, it is understood that many variations and modifications may be made while remaining within the spirit and scope of the invention.

What is claimed is:

1. A learning and memory device comprising:
a flexible plate with manually pressable and resettable buttons disposed in the plate for assisting with memory,
wherein each button includes a button head including an upper protrusion and an underside protrusion.

2. The invention of claim 1, further comprising a rigid body having holes through which the depressible and resettable buttons extend.

3. The invention of claim 2, wherein the depressible and resettable buttons are sized for manual articulation by fingers of a human hand.

4. The invention of claim 2, wherein the rigid body comprises a face plate and a back plate.

5. The invention of claim 4, wherein the back plate further comprises a peripheral rim.

6. The invention of claim 5, wherein the peripheral rim of the back plate forms a recessed rear surface.

7. The invention of claim 6, wherein the peripheral rim extends beyond the crown of the underside of the buttons when the buttons are depressed, which prevents inadvertent reset of the buttons when placed on a surface.

8. The invention of claim 7, wherein the buttons are assigned to the base integers 0-9.

9. The invention of claim 8, wherein the numbers are applied to the buttons so that the numbers can be identified by touch.

10. The invention of claim 7, wherein the buttons are assigned to the letters of the alphabet.

11. The invention of claim 8, wherein the letters are applied to the buttons so that the letters can be identified by touch.

12. The invention of claim 1, wherein the device is formed as a keyboard and each button is a key of the keyboard.

13. The invention of claim 12, wherein the keyboard is a QWERTY keyboard.

14. A learning and memory device comprising:
a flexible plate with manually pressable and resettable buttons disposed in the plate for assisting with memory;
wherein each button includes a button head including an upper protrusion and an underside protrusion;
wherein the button head of each button is connected to a tapered conical portion;
wherein the tapered conical portion extends from a periphery of the button head outwardly to connect with the flexible plate;
wherein the conical portion allows for the button head to be pressed into the flexible plate and allows the button head to snap into the pressed in position.

15. The invention of claim 14, wherein in the pressed in position, the underside of each button extends from the flexible plate and is manually articulable by a human finger so as to compress the conical portion and allow the button head to snap back to the original reset position.

16. The invention of claim 15, further comprising a rigid body having holes through which the depressible and resettable buttons extend.

17. The invention of claim 16, wherein the buttons are assigned to the base integers 0-9.

18. The invention of claim 17, wherein the numbers are applied to the buttons so that the numbers can be identified by touch.

19. The invention of claim 16, wherein the buttons are assigned to the letters of the alphabet.

20. The invention of claim 16, wherein the device is formed as a keyboard and each button is a key of the keyboard.
